(19) United States
(12) Patent Application Publication
(10) Pub. No.: US 2025/0012093 A1
(43) Pub. Date: Jan. 9, 2025

(54) COMPOSITE PLASTIC FLOOR AND PREPARATION METHOD THEREOF

(71) Applicant: Youteng Building Materials Technology (Haining) Co., Ltd., Zhejiang (CN)

(72) Inventors: Jingmu HU, Zhejiang (CN); Mark Curtis, Zhejiang (CN)

(21) Appl. No.: 18/522,673

(22) Filed: Nov. 29, 2023

(30) Foreign Application Priority Data
Jul. 5, 2023 (CN) 2023108208524

(51) Int. Cl. E04F 15/10; B32B 21/08; B32B 27/30

(52) U.S. Cl. CPC E04F 15/107; B32B 21/08; B32B 27/304; B32B 2250/04; B32B 2250/05; B32B 2255/10; B32B 2255/26; B32B 2264/10; B32B 2307/554; B32B 2307/72; B32B 2307/7376; B32B 2471/00

(57) ABSTRACT

Provided are a composite plastic floor and a preparation method thereof. The composite plastic floor includes a first substrate layer, a cork layer, a second substrate layer, a wear-resistant layer, and a coating that are laminated in sequence; where the cork layer has a thickness greater than that of the first substrate layer and the second substrate layer, and the cork layer has a density of 0.18 g/cm³ to 0.3 g/cm³; and the first substrate layer and the second substrate layer independently include 20 wt % to 50 wt % of polyvinyl chloride (PVC) and 50 wt % to 80 wt % of a stone powder.

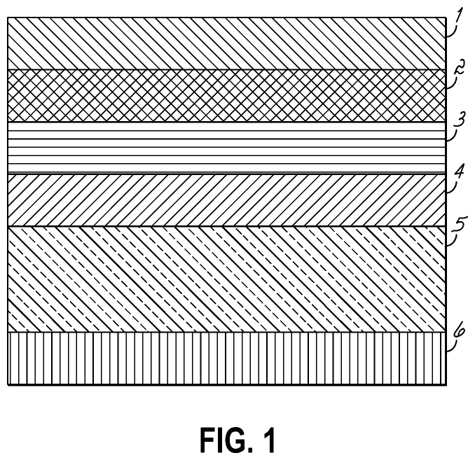

### CROSS REFERENCE TO RELATED APPLICATION

This patent application claims the benefit and priority of Chinese Patent Application No. 2023108208524 filed with the China National Intellectual Property Administration on Jul. 5, 2023, the disclosure of which is incorporated by reference herein in its entirety as part of the present application.

### TECHNICAL FIELD

The present disclosure relates to the technical field of composite floors, in particular to a composite plastic floor and a preparation method thereof.

### BACKGROUND

In the prior art, common ground decorative materials include ceramic tiles, wooden floors, or carpets, and most of their raw materials are natural. The impact of long-term excessive development of natural resources on the ecological environment cannot be underestimated. With the improvement of people's living standards, the demand for ground decorative materials increases accordingly. It has become a general trend to effectively develop and comprehensively utilize natural resources in producing ground decorative materials by composite and synthetic methods that are in line with the basic principles of energy conservation and environmental protection. These ground decorative materials should also be elegant in appearance, economical and practical, meet people's different purposes of use, and have a certain degree of comfort.

For example, Chinese patent CN201687165U discloses a polyvinyl chloride (PVC)-cork composite floor, including a substrate layer, a PVC layer, and a cork layer, wherein the PVC layer is compounded on the substrate layer by hot pressing, the cork layer is laid on a bottom surface of the substrate layer and bonded with the substrate layer as a whole, the PVC layer has a surface printed with different patterns, the patterns are covered with a wear-resistant layer, and the substrate layer is formed by mixing a stone powder and a resin. This solid wood-based decorative floor compounded with the cork substrate has flame retardancy, corrosion resistance, desirable elasticity, and excellent sound absorption effect, but shows a poor noise reduction effect.

### SUMMARY

In view of the above, an object of the present disclosure is to provide a composite plastic floor and a preparation method thereof. In the present disclosure, the composite plastic floor has an excellent noise reduction effect.

To achieve the above object, the present disclosure provides the following technical solutions:

The present disclosure provides a composite plastic floor, including a first substrate layer, a cork layer, a second substrate layer, a wear-resistant layer, and a coating that are laminated in sequence; where
the cork layer has a thickness greater than that of the first substrate layer and the second substrate layer, and the cork layer has a density of 0.18 g/cm³ to 0.3 g/cm³; and
the first substrate layer and the second substrate layer independently include 20 wt % to 50 wt % of polyvinyl chloride (PVC) and 50 wt % to 80 wt % of a stone powder.

In some embodiments, the cork layer, the first substrate layer, and the second substrate layer independently have a thicknesses of 0.5 mm to 5 mm.

In some embodiments, the wear-resistant layer includes 65 wt % to 90 wt % of PVC, 9 wt % to 34 wt % of a plasticizer, and 0.3 wt % to 1 wt % of a stabilizer; and the wear-resistant layer has a thickness of 0.06 mm to 1.0 mm.

In some embodiments, the coating is prepared from a polyurethane resin; and the coating has an areal density of 5 g/m² to 50 g/m².

In some embodiments, a decorative layer is arranged between the second substrate layer and the wear-resistant layer;
the decorative layer includes a PVC layer and a pattern on a surface of the PVC layer; and the decorative layer has a thickness of 0.05 mm to 0.07 mm.

The present disclosure further provides a method for preparing the composite plastic floor of any one of the above technical solutions, including the following steps:
(1) laying the wear-resistant layer on a surface of the second substrate layer, and subjecting a resulting system to hot pressing to obtain a surface layer; and
(2) bonding the cork layer and the first substrate layer in sequence on the surface of the second substrate layer of the surface layer, coating a paint on a surface of the wear-resistant layer of the surface layer, and then curing the paint to obtain the composite plastic floor.

The present disclosure further provides a method for preparing the composite plastic floor of any one of the above technical solutions, including the following steps:
(1) laying the wear-resistant layer on a surface of the second substrate layer, and subjecting a resulting system to hot pressing to obtain a surface layer; and
(2) bonding the first substrate layer and the cork layer to obtain a substrate-cork layer; and
(3) bonding the second substrate layer of the surface layer to the cork layer of the substrate-cork layer, coating a paint on a surface of the wear-resistant layer of the surface layer, and curing the paint to obtain the composite plastic floor; where
steps (1) and (2) are conducted in any order.

In some embodiment, under a condition that the composite plastic floor further includes the decorative layer, a process of laying the wear-resistant layer on the surface of the second substrate layer is replaced by: laying the decorative layer and the wear-resistant layer in sequence on the surface of the second substrate layer.

In some embodiment, the first substrate layer is prepared by a process including the following steps: mixing PVC and the stone powder to obtain a first mixture, and subjecting the first mixture to first internal mixing and first calendering in sequence to obtain the first substrate layer; and
the second substrate layer is prepared by the same process as the first substrate layer.

In some embodiment, the wear-resistant layer is prepared by a process including the following steps: mixing PVC, a plasticizer, and a stabilizer to obtain a second mixture, and subjecting the second mixture to second internal mixing and second calendering in sequence to obtain the wear-resistant layer.

The present disclosure provides a composite plastic floor, including a first substrate layer, a cork layer, a second substrate layer, a wear-resistant layer, and a coating that are laminated in sequence; where the cork layer has a thickness greater than that of the first substrate layer and the second substrate layer, and the cork layer has a density of 0.18 g/cm³ to 0.3 g/cm³; and the first substrate layer and the second substrate layer independently include 20 wt % to 50 wt % of PVC and 50 wt % to 80 wt % of a stone powder. In the composite plastic floor provided by the present disclosure, the thickness of the cork layer is greater than that of a single substrate layer (the first substrate layer and the substrate layer). Thus, when being used as a floor, the composite plastic floor including the cork layer with greater thickness shows a desirable noise reduction effect and is comfortable to go on foot. The cork layer can also significantly reduce a density of the composite plastic floor, and lower a transportation cost of the composite plastic floor. The wear-resistant layer can improve a wear-resistant performance of the composite plastic floor. The coating can protect the composite plastic floor from being scratched, and improve gloss and aesthetics of the composite plastic floor.

The present disclosure further provides a method for preparing the composite plastic floor as described above. The method has simple production process, convenient operations, and low production cost, and is suitable for industrialized production.

### BRIEF DESCRIPTION OF THE DRAWINGS

FIGURE shows a schematic diagram of a composite plastic floor prepared according to example 1, where 1 represents a first substrate layer, 2 represents a cork layer, 3 represents a second substrate layer, 4 represents a decorative layer, 5 represents a wear-resistant layer, and 6 represents a coating.

### DETAILED DESCRIPTION OF THE EMBODIMENTS

The present disclosure provides a composite plastic floor, including a first substrate layer, a cork layer, a second substrate layer, a wear-resistant layer, and a coating that are laminated in sequence; where the cork layer has a thickness greater than that of the first substrate layer and the second substrate layer.

In the present disclosure, the composite plastic floor includes a first substrate layer; and the first substrate layer includes 20 wt % to 50 wt %, preferably 25 wt % to 45 wt %, and more preferably 30 wt % to 40 wt % of PVC. In some embodiments, the PVC includes a PVC resin powder SG-5 and/or a PVC resin powder SG-8. In the present disclosure, the first substrate layer further includes 50 wt % to 80 wt %, preferably 55 wt % to 75 wt %, and more preferably 60 wt % to 70 wt % of a stone powder. In some embodiments, the stone powder is a calcium powder. In some embodiments, the stone powder has a particle size of 100 mesh to 600 mesh, preferably 150 mesh to 500 mesh, and more preferably 150 mesh to 400 mesh. In some embodiments, the first substrate layer has a thickness of 0.5 mm to 5 mm, specifically 0.5 mm, 1 mm, 1.5 mm, 2 mm, 2.5 mm, 3 mm, 3.5 mm, 4 mm, 4.5 mm, or 5 mm.

In the present disclosure, the composite plastic floor includes a cork layer on a surface of the first substrate layer. In some embodiments, the cork layer has a density of 0.18 g/cm³ to 0.3 g/cm³, preferably 0.2 g/cm³ to 0.24 g/cm³. In some embodiments, the cork layer has a thickness of 0.5 mm to 5 mm, specifically 0.5 mm, 1 mm, 1.5 mm, 2 mm, 2.5 mm, 3 mm, 3.5 mm, 4 mm, 4.5 mm, or 5 mm.

In the present disclosure, the composite plastic floor includes a second substrate layer on a surface of the cork layer; the second substrate layer includes: 20 wt % to 50 wt %, preferably 25 wt % to 45 wt %, and more preferably 30 wt % to 40 wt % of PVC. In some embodiments, the PVC includes a PVC resin powder SG-5 and/or a PVC resin powder SG-8. In the present disclosure, the first substrate layer further includes 50 wt % to 80 wt %, preferably 55 wt % to 75 wt %, and more preferably 60 wt % to 70 wt % of a stone powder. In some embodiments, the stone powder is a calcium powder. In some embodiments, the stone powder has a particle size of 100 mesh to 600 mesh, preferably 150 mesh to 500 mesh, and more preferably 150 mesh to 400 mesh. In some embodiments, the second substrate layer has a thickness of 0.5 mm to 5 mm, specifically 0.5 mm, 1 mm, 1.5 mm, 2 mm, 2.5 mm, 3 mm, 3.5 mm, 4 mm, 4.5 mm, or 5 mm.

In some embodiments of the present disclosure, the composite plastic floor further includes a decorative layer on a surface of the second substrate layer, and the decorative layer includes a PVC layer and a pattern on a surface of the PVC layer. In the present disclosure, there is no special limitation on the pattern, and a pattern well known to those skilled in the art can be used. In some embodiments, the decorative layer makes the composite plastic floor more beautiful. In some embodiments, the decorative layer has a thickness of 0.05 mm to 0.07 mm, preferably 0.055 mm to 0.065 mm, and more preferably 0.06 mm.

In the present disclosure, the composite plastic floor includes a wear-resistant layer on a surface of the decorative layer. In some embodiments, the wear-resistant layer includes 65 wt % to 90 wt %, preferably 69.08 wt % to 69.61 wt %, and more preferably 69.4 wt % of PVC; 9 wt % to 34 wt %, preferably 29.8 wt % wt % to 30.2 wt %, and more preferably 30 wt % of a plasticizer; and 0.3 wt % to 1 wt %, preferably 0.59 wt % to 0.61 wt %, and more preferably 0.6 wt % of a stabilizer. In some embodiments, the plasticizer includes dioctyl terephthalate (DOTP). In some embodiments, the stabilizer includes a calcium zinc stabilizer. In some embodiments, the wear-resistant layer has a thickness of 0.06 mm to 1 mm, preferably 0.2 mm to 0.8 mm, and more preferably 0.5 mm to 0.7 mm.

In the present disclosure, the composite plastic floor includes a coating on a surface of the wear-resistant layer. In some embodiments, the coating is a polyurethane resin (PU resin). In some embodiments, the coating has an areal density of 5 g/m² to 50 g/m², preferably 10 g/m² to 40 g/m², and more preferably 10 g/m² to 30 g/m².

The present disclosure further provides a method for preparing the composite plastic floor of any one of the above technical solutions, including the following steps:
(1) laying the wear-resistant layer on a surface of the second substrate layer, and subjecting a resulting system to hot pressing to obtain a surface layer; and
(2) bonding the cork layer and the first substrate layer in sequence on the surface of the second substrate layer of the surface layer, coating a paint on a surface of the wear-resistant layer of the surface layer, and curing the paint to obtain the composite plastic floor.

Unless otherwise specified, raw materials used in the present disclosure are all commercially available commodities.

In some embodiments of the present disclosure, the substrate layer is prepared by a process including the following steps: mixing PVC and the stone powder to obtain a first mixture, and subjecting the first mixture to first internal mixing and first calendering in sequence to obtain the substrate layer; and the substrate layer is the first substrate layer or the second substrate layer (that is, the first substrate layer and the second substrate layer have a same preparation method). In some embodiments, the internal mixing is conducted at a temperature of 165° C. to 175° C., preferably 168° C. to 172° C., and more preferably 170° C. for 7 min to 9 min, preferably 7.5 min to 8.5 min, and more preferably 8 min. In some embodiments, the calendering is conducted at a temperature of 168° C. to 172° C., preferably 169° C. to 171° C., and more preferably 170° C. In some embodiment, the calendering is conducted at a rate of 19.5 m/min to 20.5 m/min, preferably 19.8 m/min to 20.2 m/min, and more preferably 20 m/min. In some embodiments, after the first calendering is completed, an obtained substrate layer is wound up.

In the present disclosure, the wear-resistant layer is prepared by a process including the following steps: mixing PVC, a plasticizer, and a stabilizer to obtain a second mixture, and subjecting the second mixture to second internal mixing and second calendering in sequence to obtain the wear-resistant layer. In some embodiments, the second internal mixing and the second calendering are conducted under the same conditions as those of the first internal mixing and the first calendering, and will not be repeated here.

In the present disclosure, the wear-resistant layer is laid on a surface of the second substrate layer, and the resulting system are subjected to hot pressing (recorded as first hot pressing) to obtain a surface layer. When the composite plastic floor further includes a decorative layer, a process of laying the wear-resistant layer on the surface of the second substrate layer is replaced by: laying the decorative layer and the wear-resistant layer in sequence on the surface of the second substrate layer. In some embodiments, the first hot pressing is conducted at a temperature of 138° C. to 142° C., preferably 139° C. to 141° C., and more preferably 140° C. In some embodiments, the first hot pressing includes first-stage hot pressing, second-stage hot pressing, and third-stage hot pressing that are conducted in sequence. In some embodiments, the first-stage hot pressing is conducted at a pressure of 4.9 MPa to 5.1 MPa, preferably 5 MPa for 4.5 min to 5.5 min, preferably 5 min; the second-stage hot pressing is conducted at a pressure of 5.9 MPa to 6.1 MPa, preferably 6 MPa for 14.5 min to 15.5 min, preferably 15 min; and the third-stage hot pressing is conducted at a pressure of 7.9 MPa to 8.1 MPa, preferably 8 MPa for 19.5 min to 20.5 min, preferably 20 min.

In the present disclosure, after obtaining the surface layer, the cork layer and the first substrate layer is bonded (recorded as first bonding) in sequence on a surface of the second substrate layer of the surface layer, a paint is coated (recorded as first coating) on a surface of the wear-resistant layer of the surface layer, and then the paint is subjected to curing (recorded as first curing) to obtain the composite plastic floor; where the bonding and the coating are conducted in any order. In some embodiments, the first bonding is conducted with a binder including a PUR hot melt adhesive or a two-component AB adhesive; and the first bonding is conducted at a gluing amount of 30 g/m² to 80 g/m², preferably 40 g/m² to 70 g/m², and more preferably 50 g/m² to 60 g/m². In some embodiments, the first coating is conducted by roll coating; there is no special limitation on the roll coating, as long as a coating with an areal density of 5 g/m² to 50 g/m² can be obtained. In some embodiments, the first curing is conducted at ambient temperature, and the first curing is conducted by ultraviolet curing; there is no special limitation on a time for the first curing, as long as a dry coating can be formed.

The present disclosure further provides a method for preparing the composite plastic floor of any one of the above technical solutions, including the following steps:
(1) laying the wear-resistant layer on a surface of the second substrate layer, and subjecting a resulting system to hot pressing (recorded as second hot pressing) to obtain a surface layer;
(2) bonding (recorded as second bonding) the first substrate layer and the cork layer to obtain a substrate-cork layer; and
(3) bonding (recorded as third bonding) the second substrate layer of the surface layer to the cork layer of the substrate-cork layer, coating (recorded as second coating) a paint on a surface of the wear-resistant layer of the surface layer, and curing (recorded as second curing) the paint to obtain the composite plastic floor; where
steps (1) and (2) are conducted in any order.

In some embodiments of the present disclosure, the second hot pressing is conducted under the same conditions as those of the first hot pressing, the second bonding and the third bonding are conducted under the same conditions as those of the first bonding; the method of the second coating is preferably the same as that of the first coating, and the second curing is conducted under the same conditions as those of the first curing, which will not be repeated here.

The technical solutions of the present disclosure will be clearly and completely described below with reference to the examples of the present disclosure. Apparently, the described examples are merely a part rather than all of the examples of the present disclosure. All other embodiments obtained by those skilled in the art based on the embodiments of the present disclosure without creative efforts shall fall within the scope of the present disclosure.

In the following examples and comparative examples, PVC is a PVC resin powder SG-8; a calcium powder has a particle size of 150 mesh to 400 mesh; a cork layer has a density of 0.2 g/cm³ to 0.4 g/cm³; a plasticizer is DOTP; a calcium zinc stabilizer is purchased from Hunan Jiaquan New Material Technology Co., Ltd., China; and a PU resin is purchased from Hunan Sunshine New Material Co., Ltd, China.

### Example 1

A first substrate layer consisted of 30 wt % of PVC and 70 wt % of a calcium powder. The first substrate layer had a thickness of 1 mm. The first substrate layer was prepared as follows: PVC and the calcium powder were mixed to be uniform, and the resulting mixture was then subjected to internal mixing at a temperature of 170° C. for 8 min and calendering at a rate of 50 m/min and a temperature of 170° C. in sequence to obtain the first substrate layer.

A cork layer had a density of 0.2 g/cm³ to 0.4 g/cm³ and a thickness of 2 mm.

A second substrate layer consisted of 30 wt % of PVC and 70 wt % of a calcium powder. The second substrate layer had a thickness of 1 mm. The second substrate layer was prepared as follows: PVC and the calcium powder were mixed to be uniform, and the resulting mixture was then subjected to internal mixing at a temperature of 170° C. for 8 min and calendering at a rate of 50 m/min and a temperature of 170° C. in sequence to obtain the second substrate layer.

A decorative layer consisted of a PVC layer and a pattern on a surface of the PVC layer, and the decorative layer had a thickness of 0.07 mm.

A wear-resistant layer consisted of 69.4 wt % of PVC, 30 wt % of DOTP, and 0.6 wt % of a calcium zinc stabilizer. The wear-resistant layer had a thickness of 0.5 mm. The wear-resistant layer was prepared as follows: PVC, DOTP, and the calcium zinc stabilizer were mixed to be uniform, and the resulting mixture was then subjected to internal mixing at a temperature of 170° C. for 8 min and calendering at a rate of 50 m/min and a temperature of 170° C. in sequence to obtain the wear-resistant layer.

A coating had an areal density of 15 g/m².

A composite plastic floor was prepared by the following procedures, and the structure thereof is shown in the FIGURE:

The decorative layer and the wear-resistant layer were sequentially laid on a surface of the second substrate layer, and subjected to hot pressing at a temperature of 140° C. and a pressure of 5 MPa for 5 min, at a temperature of 140° C. and a pressure of 6 MPa for 15 min, and at a temperature of 140° C. and a pressure of 8 MPa for 20 min in sequence to obtain a surface layer.

The cork layer and the first substrate layer were bonded in sequence on the surface of the second substrate layer of the surface layer, a PU resin was roll-coated on a surface of the wear-resistant layer of the surface layer, and then the coated PU resin was subjected to UV curing at ambient temperature to obtain the composite plastic floor. A binder used for the bonding was a two-component AB adhesive, and used at a gluing amount of 80 g/m². The composite plastic floor had a density of 1.28 g/cm³; a shrinkage rate of the composite plastic floor was tested twice, being 0.05% and 0.01% separately; and noise measured by a tapping method was 52 db to 55 db.

### Example 2

A first substrate layer consisted of 25 wt % of PVC and 75 wt % of a calcium powder. The first substrate layer had a thickness of 0.7 mm. The first substrate layer is prepared as follows: PVC and the calcium powder were mixed to be uniform, and the resulting mixture was then subjected to internal mixing at a temperature of 170° C. for 8 min and calendering at a rate of 50 m/min and a temperature of 170° C. in sequence to obtain the first substrate layer.

A cork layer had a density of 0.2 g/cm³ to 0.4 g/cm³ and a thickness of 1.5 mm.

A second substrate layer consisted of 25 wt % of PVC and 75 wt % of a calcium powder. The second substrate layer had a thickness of 0.8 mm. The second substrate layer was prepared by a process conducted as follows: PVC and the calcium powder were mixed to be uniform, and the resulting mixture was then subjected to internal mixing at a temperature of 170° C. for 8 min and calendering at a rate of 50 m/min and a temperature of 170° C. in sequence to obtain the second substrate layer.

A decorative layer consisted of a PVC layer and a pattern on a surface of the PVC layer, and the decorative layer had a thickness of 0.07 mm.

A wear-resistant layer consisted of 72 wt % of PVC, 27.6 wt % of DOTP, and 0.4 wt % of a calcium zinc stabilizer. The wear-resistant layer had a thickness of 0.3 mm. The wear-resistant layer was prepared by a process conducted as follows: PVC, the DOTP, and the calcium zinc stabilizer were mixed to be uniform, and the resulting mixture was then subjected to internal mixing at a temperature of 170° C. for 8 min and calendering at a rate of 50 m/min and a temperature of 170° C. in sequence to obtain the wear-resistant layer.

A coating had an areal density of 12 g/m².

A composite plastic floor was prepared by a process by the following procedures:

The decorative layer and the wear-resistant layer were sequentially laid on a surface of the second substrate layer, and subjected to hot pressing at a temperature of 140° C. and a pressure of 5 MPa for 5 min, at a temperature of 140° C. and a pressure of 6 MPa for 15 min, and at a temperature of 140° C. and a pressure of 8 MPa for 20 min in sequence to obtain a surface layer.

The cork layer and the first substrate layer were bonded in sequence on the surface of the second substrate layer of the surface layer, a PU resin was roll-coated on a surface of the wear-resistant layer of the surface layer, and then the coated PU resin was subjected to UV curing at ambient temperature to obtain the composite plastic floor. A binder used for the bonding was a PUR hot melt adhesive, and used at a gluing amount of 50 g/m². The composite plastic floor had a density of 1.3 g/cm³; a shrinkage rate of the composite plastic floor was tested twice, being 0.09% both.

### Example 3

A first substrate layer consisted of 50 wt % of PVC and 50 wt % of a calcium powder. The first substrate layer had a thickness of 2 mm. The first substrate layer was prepared as follows: PVC and the calcium powder were mixed to be uniform, and the resulting mixture was then subjected to internal mixing at a temperature of 170° C. for 8 min and calendering at a rate of 50 m/min and a temperature of 170° C. in sequence to obtain the first substrate layer.

A cork layer had a density of 0.2 g/cm³ to 0.4 g/cm³ and a thickness of 4 mm.

A second substrate layer consisted of 50 wt % of PVC and 50 wt % of a calcium powder. The second substrate layer had a thickness of 2 mm. The second substrate layer was prepared by a process conducted as follows: PVC and the calcium powder were mixed to be uniform, and the resulting mixture was then subjected to internal mixing at a temperature of 170° C. for 8 min and calendering at a rate of 50 m/min and a temperature of 170° C. in sequence to obtain the second substrate layer.

A decorative layer consisted of a PVC layer and a pattern on a surface of the PVC layer, and the decorative layer had a thickness of 0.07 mm.

A wear-resistant layer consisted of 72 wt % of PVC, 27.6 wt % of DOTP, and 0.4 wt % of a calcium zinc stabilizer. The wear-resistant layer had a thickness of 0.7 mm. The wear-resistant layer was prepared by a process conducted as follows: PVC, DOTP, and the calcium zinc stabilizer were mixed to be uniform, and the resulting mixture was then subjected to internal mixing at a temperature of 170° C. for 8 min and calendering at a rate of 50 m/min and a temperature of 170° C. in sequence to obtain the wear-resistant layer.

A coating had an areal density of 25 g/m².

A composite plastic floor was prepared by the following procedures:

The decorative layer and the wear-resistant layer were sequentially laid on a surface of the second substrate layer, and subjected to hot pressing at a temperature of 140° C. and a pressure of 5 MPa for 5 min, at a temperature of 140° C. and a pressure of 6 MPa for 15 min, and at a temperature of 140° C. and a pressure of 8 MPa for 20 min in sequence to obtain a surface layer.

The cork layer and the first substrate layer were bonded in sequence on the surface of the second substrate layer of the surface layer, a PU resin was roll-coated on a surface of the wear-resistant layer of the surface layer, and then the coated PU resin was subjected to UV curing at ambient temperature to obtain the composite plastic floor. A binder used for the bonding was a two-component AB adhesive, and used at a gluing amount of 80 g/m². The composite plastic floor had a density of 1.29 g/cm³; a shrinkage rate of the composite plastic floor was tested twice, being 0.09% and −0.01% separately.

### Comparative Example 1

A composite plastic floor was prepared according to the preparation method of Example 1 except that the positions of the cork layer and the first substrate layer were exchanged (that is, the cork layer was arranged at a bottom layer). The composite plastic floor had noise of 70 db to 74 db as measured by a beating method.

### Comparative Example 2

A composite plastic floor was prepared according to the preparation method of Example 1 except that there was no cork layer. The composite plastic floor had noise of 79 db to 83 db as measured by a beating method.

The above descriptions are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

1. A composite plastic floor, comprising:
a first substrate layer, a cork layer, a second substrate layer, a wear-resistant layer, and a coating that are laminated in sequence;
wherein the cork layer has a density of 0.18 g/cm³ to 0.3 g/cm³; and the first substrate layer and the second substrate layer independently comprise 20 wt % to 50 wt % of polyvinyl chloride (PVC) and 50 wt % to 80 wt % of a stone powder.

2. The composite plastic floor of claim 1, wherein the cork layer, the first substrate layer, and the second substrate layer independently have a thicknesses of 0.5 mm to 5 mm.

3. The composite plastic floor of claim 1, wherein the wear-resistant layer comprises 65 wt % to 90 wt % of PVC, 9 wt % to 34 wt % of a plasticizer, and 0.3 wt % to 1 wt % of a stabilizer; and the wear-resistant layer has a thickness of 0.06 mm to 1.0 mm.

4. The composite plastic floor of claim 1, wherein the coating is prepared from a polyurethane resin; and the coating has an areal density of 5 g/m² to 50 g/m².

5. The composite plastic floor of claim 1, wherein a decorative layer is arranged between the second substrate layer and the wear-resistant layer; and
the decorative layer comprises a PVC layer and a pattern on a surface of the PVC layer; and the decorative layer has a thickness of 0.05 mm to 0.07 mm.

6. A method for preparing the composite plastic floor of claim 1, comprising the following steps:
(1) laying the wear-resistant layer on a surface of the second substrate layer, and subjecting a resulting system to hot pressing to obtain a surface layer; and
(2) bonding the cork layer and the first substrate layer in sequence on the surface of the second substrate layer of the surface layer, coating a paint on a surface of the wear-resistant layer of the surface layer, and curing the paint to obtain the composite plastic floor.

7. (canceled)

8. The method of claim 6, wherein under a condition that the composite plastic floor further comprises a decorative layer, a process of laying the wear-resistant layer on the surface of the second substrate layer is replaced by: laying the decorative layer and the wear-resistant layer in sequence on the surface of the second substrate layer.

9. The method of claim 6, wherein the first substrate layer is prepared by a process comprising:
mixing PVC and the stone powder to obtain a first mixture, and
subjecting the first mixture to first internal mixing and first calendering in sequence to obtain the first substrate layer; and
the second substrate layer is prepared by the same as that of the first substrate layer.

10. The method of claim 6, wherein the wear-resistant layer is prepared by a process comprising the following steps:
mixing PVC, a plasticizer, and a stabilizer to obtain a second mixture, and subjecting the second mixture to second internal mixing and second calendering in sequence to obtain the wear-resistant layer.

11. The method of claim 6, wherein the cork layer, the first substrate layer, and the second substrate layer independently have a thicknesses of 0.5 mm to 5 mm.

12. The method of claim 6, wherein the wear-resistant layer comprises 65 wt % to 90 wt % of PVC, 9 wt % to 34 wt % of a plasticizer, and 0.3 wt % to 1 wt % of a stabilizer; and
the wear-resistant layer has a thickness of 0.06 mm to 1.0 mm.

13. The method of claim 6, wherein the coating is prepared from a polyurethane resin; and the coating has an areal density of 5 g/m² to 50 g/m².

14. The method of claim 6, wherein a decorative layer is arranged between the second substrate layer and the wear-resistant layer; and
the decorative layer comprises a PVC layer and a pattern on a surface of the PVC layer; and the decorative layer has a thickness of 0.05 mm to 0.07 mm.

15. A method for preparing the composite plastic floor of claim 1, comprising the following steps:
(1) laying the wear-resistant layer on a surface of the second substrate layer, and subjecting a resulting system to hot pressing to obtain a surface layer; and
(2) bonding the first substrate layer and the cork layer to obtain a substrate-cork layer; and
(3) bonding the second substrate layer of the surface layer to the cork layer of the substrate-cork layer, coating a paint on a surface of the wear-resistant layer of the surface layer, and curing the paint to obtain the composite plastic floor; wherein
steps (1) and (2) are conducted in any order.

16. The method of claim 15, wherein under a condition that the composite plastic floor further comprises a decorative layer, a process of laying the wear-resistant layer on the surface of the second substrate layer is replaced by: laying the decorative layer and the wear-resistant layer in sequence on the surface of the second substrate layer.

17. The method of claim 15, wherein the first substrate layer is prepared by a process comprising: mixing PVC and the stone powder to obtain a first mixture, and subjecting the first mixture to first internal mixing and first calendering in sequence to obtain the first substrate layer; and
the second substrate layer is prepared by the same as that of the first substrate layer.

18. The method of claim 15, wherein the wear-resistant layer is prepared by a process comprising the following steps:
mixing PVC, a plasticizer, and a stabilizer to obtain a second mixture, and subjecting the second mixture to second internal mixing and second calendering in sequence to obtain the wear-resistant layer.

19. The method of claim 15, wherein the cork layer, the first substrate layer, and the second substrate layer independently have a thicknesses of 0.5 mm to 5 mm.

20. The method of claim 15, wherein the wear-resistant layer comprises 65 wt % to 90 wt % of PVC, 9 wt % to 34 wt % of a plasticizer, and 0.3 wt % to 1 wt % of a stabilizer;
the wear-resistant layer has a thickness of 0.06 mm to 1.0 mm, and
the coating is prepared from a polyurethane resin; and the coating has an areal density of 5 g/m² to 50 g/m².

21. The method of claim 15, wherein a decorative layer is arranged between the second substrate layer and the wear-resistant layer; and
the decorative layer comprises a PVC layer and a pattern on a surface of the PVC layer; and the decorative layer has a thickness of 0.05 mm to 0.07 mm.
